(19) United States
(12) Patent Application Publication
(10) Pub. No.: US 2004/0044657 A1
(43) Pub. Date: Mar. 4, 2004

(54) Internet searching system to be easy by user and method thereof

(76) Inventor: Jae-Hak Lee, Kyunggi-do (KR)

Correspondence Address: Frank Chau, F Chau & Associates, Suite 501, 1900 Hempsted Turnpike, East Meadow, NY, 11554, US

(21) Appl. No.: 10/363,769

(22) PCT Filed: Sep. 6, 2001
(86) PCT No.: PCT/KR01/01511

(30) Foreign Application Priority Data
Sep. 6, 2000 (KR) 2000/52698

(51) Int. Cl. G06F 17/30; G06F 7/00

(52) U.S. Cl. 707/3; 707/10

(57) ABSTRACT

Disclosed herein is an Internet search system and method for easy search. In the system and method, a user classifies various pieces of Web site information into categories and stores them in databases (DBs), the characteristic of Web sites having been accessed by the user is analyzed using cookies and/or temporary Internet files formed in the user Internet access means when the user performs search through the search engine and search results are first outputted according to an analyzed characteristic. As a result, rapid and convenient search can be carried out, Web sites can be searched, and search results near the position of a user can be displayed and various forms of search can be performed in keyword-based search engines classified into general keyword-base search engines, front-end type search engines and intelligent search engines, and subject-based search engines.

### TECHNICAL FIELD

The present invention relates generally to an Internet search system and method for easy search, and more particularly to an Internet search system and method for easy search, in which a user classifies various pieces of Web site information into categories and stores them in databases (DBs), the characteristic of Web sites having been accessed by the user is analyzed using cookies and/or temporary Internet files formed in the user Internet access means when the user performs search through the search engine and search results are first outputted according to an analyzed characteristic, so that rapid and convenient search can be carried out, Web sites can be searched, and search results near the position of a user can be displayed and various forms of search can be performed in keyword-based search engines classified into general keyword-base search engines, front-end type search engines and intelligent search engines, and subject-based search engines.

### BACKGROUND ART

The Internet is a huge and effective medium of information accumulation and provision in which numerous servers all over the world are connected to one another, and is used for various purposes such as electronic mail, news group service, file transfer, information transfer, information search and the like.

The Internet has been expanded faster than expected. Internet sites are doubled every four months. The reason for this is that individuals as well as companies create homepages for public relationship. A lot of people put matters of concern over various fields, such as art, literature, science, medicine, entertainment, sports, politics, technology, economics or the like, in their home pages. Daily news ranging from the trivial to the professional which is produced all over the world, is dealt with in news groups that are formed by people having the same concerns in each field.

As the contents of the Internet become various, the amount of information provided via the Internet mushrooms. Accordingly, in order to select desired information from numerous pieces of information on the Internet, a special technique is required. A search engine can implement the technique.

The search engine refers to an Internet site that helps users to search numerous sites on the Internet for a site containing desired information. Several hundreds of search engines are present throughout the Internet.

Criteria for classifying search engines have not been officially established. However, the search engines are generally classified into subject-based search engines and keyword-based search engines according to the patterns of operations. The keyword-based search engines are classified into general keyword-based search engines, front-end type search engines and intelligent search engines.

However, all the search engines are not classified clearly as described above. That is, a representative search engine of subject-based search engines, YAHOO™, supports keyword-based search. The keyword-based search engines mostly support subject-based search as well as keyword-based search at the same time.

The subject-based search engines refer to search engines that provide lists in which information on the Internet is classified according to subjects such as society, culture, art, sports, politics or the like. They are called directory servers, subject-based catalogues and menu search engines. The subject-based search engines are advantageous in that they can easily approach corresponding information when an accurate keyword cannot be selected, but disadvantageous in that there is danger that they may not approach the information by erroneous intermediate step because they should go through various steps, such as upper classification, intermediate classification and lower classification.

The general keyword-based search engines refer to search engines in which homepage contents and Uniform Resource Locators (URLs; or homepage addresses) are arranged in its own database. The general keyword-based search engines are advantageous in that desired information can be searched for only by inputting several keywords, but disadvantageous in that a large amount of time is wasted because of the output of erroneous results when an accurate keyword cannot be selected. The front-end type search engines refer to search engines in which various search engines are collected in a single screen. The front-end type search engines do not construct their own database, but only provide the various query boxes of various search engines. They are called front-end type search engines because they function as interfaces with different search engines. The front-end type search engines are advantageous in that a variety of search engines can be used within a single screen without the inconvenience of moving from one search engine to another and opened software, news groups and scientific documents as well as HyperText Markup Language (HTML) documents can be searched by the search engines, but disadvantageous in that they cannot support the various search options of each search engine and have limitations on accurate search because they do not have their own databases.

Meanwhile, the intelligent search engine refers to a search engine that search for information by a multithread technique using a robot agent. For the front-end type search engines, a query box is provided to each search engine; whereas, for intelligent search engines, a single query box is provided to several tens of search engines to provide simultaneous search function by means of the plural search engines. Search is carried out by a one-time keyword input with reference to various search engines. As a result, the intelligent search engines are advantageous in that information is simply searched for and outputted results are obtained from various search engines, but are disadvantageous in that plural search engines are referred to and decreases search speed and a large amount of time is required to select desired information among results searched for by plural search engines and outputted on a single screen.

The above-described search engines output search results on a single screen, so excessive pieces of information except desired information are outputted. Accordingly, large amounts of time and effort are required to select desired information among the outputted information. Additionally, when the user desires to search for information in a local area, excessive pieces of information except desired information are outputted, thereby preventing precise information from being obtained.

For example, when a user living in Busan outputs search results with a keyword “movie” entered into various search engines so as to obtain information about movies now showing at theaters in Busan, all information about movies showing at theaters in the remaining regions except for Busan is outputted, thus causing a large amount of time to be required to select desired information among the outputted information.

That is, the conventional search engines are problematic in that it is difficult to search for homepages or information having regional characteristics or information near the position of the user

Meanwhile, a cookie is a text file temporarily used to store a current state in a web browser. The cookie stores information about an environment in which a terminal previously accessed the Internet and is used at the time of next access. A web browser does not adopt a concept of state, so the cookie is introduced to supplement no provision of the concept of state. A temporary Internet file is a file for temporarily storing the file of a Web site when the Internet is accessed. The temporary Internet file aims to generate a cookie or be used at the time of next access. However, in practice, the temporary Internet file is used only to increase an Internet access speed, but does not perform special functions. Accordingly, users delete the temporary Internet file often, and the temporary Internet file is considered as just occupying the much capacity of a computer.

Transmission Control Protocol/Internet Protocol (TCP/IP) is one of network protocol communication control procedures. When data are transmitted via a network, data are divided into units called packets and transmitted. In this case, IP functions to move data packet from one location to another, while TCP functions to manage data flow and determine whether the data are correct. TCP/IP is a collection of one hundred or more protocols. TCP/IP is a protocol used on ARPANET that connects the computers of the Advanced Research Projects Agency, Universities and laboratories, and, thereafter, is improved and standardized by U.S. Department of Defense. TCP/IP has been used as a computer network protocol, in particular, an International standard protocol for Unix. In the Open Systems Interconnection (OSI) Reference Model, TCP falls under a transport layer and IP falls under a network layer.

TCP/IP is not used for different purposes except for the above-described purposes.

### DISCLOSURE OF THE INVENTION

Accordingly, the present invention has been made keeping in mind the above problems occurring in the prior art, and an object of the present invention is to provide an Internet search system and method for easy search, which first notifies a user of search results suitable for the characteristic of Web sites having been accessed by the user when the user desires to search for information using a search engine, thereby allowing the user to rapidly and conveniently search for Web sites as well as information.

Another object of the present invention is to provide an Internet search system and method for easy search, which can search for information near the position of a user according to the position of the user.

Still another object of the present invention is to provide an Internet search system and method, which allows information in a certain region to be easily obtained and various forms of search to be easily carried out.

In order to accomplish the above and other objects, the present invention provides an Internet search system and method, in which a user classifies various pieces of Web site information into categories and stores them in DBs, the characteristic of Web sites having been accessed by the user is analyzed using cookies and/or temporary Internet files formed in the user Internet access means when the user performs search through the search engine, search results are outputted according to an analyzed characteristic, keyword-based search as well as subject-based search is provided, information is databased so that the information is classified according to administrative regions and information near the user is first outputted as search results by ascertaining the position of the user or inputting a predetermined symbol, so that time and effort to select desired information can be saved, and regional, industry and subject index groups are arranged in a three-dimensional form so desired information can be accurately searched for using a single query box.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a construction of an Internet search system in accordance with the present invention;

FIG. 2 is a flowchart showing part of an Internet search method in accordance with the present invention; and

FIG. 3 is a view of an example showing a screen of a user terminal to explain part of the Internet search method of the present invention.

### DESCRIPTION OF REFERENCE NUMERALS OF PRINCIPAL PARTS OF THE DRAWINGS

10: user terminal 11: cookies

12: temporary Internet file

13: TCP/IP 14: position data transmission means

15: communication means 16: sensing or artificial intelligence robot

20: Internet Service Provider (ISP) server

21: position data transmission means 30: administrator server

31: search engine main server

32, 32′, 32″: search engine server sub-server

33: position data reception means 34: position data analysis means

35, 35′, 36″, . . . :DBs 36: control unit

37: sensing program 38: artificial intelligence robot

40: regional index group 41: subject index group

42: industrial index group 43: query box

### BEST MODE FOR CARRYING OUT THE INVENTION

The present invention is described in more detail below.

An Internet search system for easy search in accordance with the present invention comprises a user terminal for accessing the Internet, searching a variety of Web sites and obtaining necessary information, said user terminal being comprised of cookies and/or temporary Internet files in which information about Web sites having been accessed by the user terminal is automatically stored, a TCP/IP for transferring data packet from one position to another, managing data flow and determining whether data are correct or not when data transmission is carried out through a network, position data transmission means including a global positioning system or geographic information system, communication means connectable to the Internet and a sensing or artificial intelligence robot; an administrator server comprised of position data reception means for receiving position data transmitted from the position data transmission means, position data analysis means for analyzing position data received, a plurality of databases in which data collected and classified by an artificial intelligence robot are stored, a plurality of search engine sub-servers for administering the databases, and selecting data and providing results in response to a command, a main server for administering the sub-servers, and a control unit for administering the server, the databases, an artificial intelligence robot and a sensing program; and an Internet service provider server provided with a position data transmission means if necessary.

An Internet search method for easy search in accordance with the present invention characterized in that a user classifies various pieces of Web site information into categories and stores them in DBs, the characteristic of Web sites having been accessed by the user is analyzed using cookies and/or temporary Internet files formed in the user Internet access means when the user performs search through the search engine, search results are outputted according to an analyzed characteristic, keyword-based search as well as subject-based search is provided, information is databased so that the information is classified according to administrative regions and information near the user is first outputted as search results by ascertaining the position of the user or inputting a predetermined symbol, so that time and effort to select desired information can be saved, and regional, industry and subject index groups are arranged in a three-dimensional form so desired information can be accurately searched for using a single query box.

Information about all cases in which the user searches for a specific Web site using a search engine provided by the administrator server and accesses a specific Web site by directly inputting the uniform resource locator of the corresponding Web site in a browser window provided by the user terminal, is automatically stored in cookies and/or temporary Internet files of the user Internet access means.

In addition, a variety of data are stored in the TCP/IP that functions to transfer a data packet from one position to another, manage the flow of data and determine whether data are correct or not when data transmission is carried out through a network.

The information of Web sites and transmitted data automatically stored in the cookies and/or temporary Internet files of the user Internet access means and the TCP/IP is utilized when the user accesses a search engine to search for information and inputs a keyword thereafter.

That is, when the user accesses a search engine to search for information and inputs a keyword, the search engine learns the characteristics of the information of Web sites and transmitted data automatically stored in the cookies and/or temporary Internet files of the user Internet access means and the TCP/IP, and displays first search results having characteristics identical with the characteristics of information obtained from previous search results and data previously transmitted.

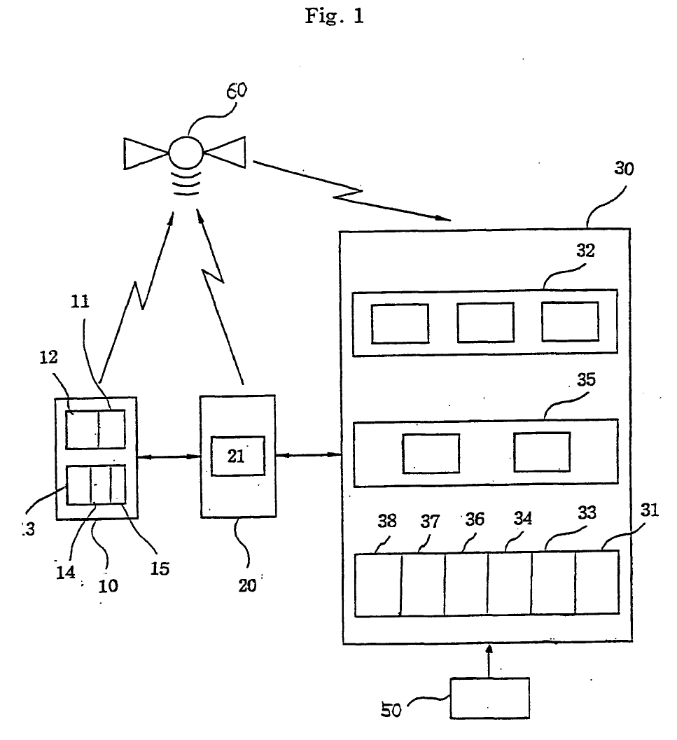

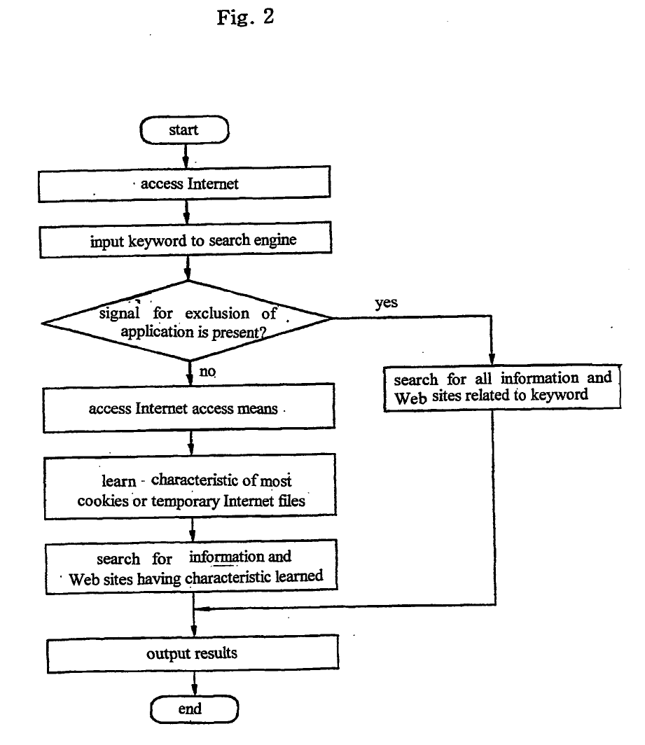

As shown in FIGS. 1 and 2, the present invention provides an Internet search system for easy search, comprising a user terminal 10 for accessing the Internet, searching a variety of Web sites and obtaining necessary information, said user terminal being comprised of cookies 11 and/or temporary Internet files 12 in which information about Web sites having been accessed by the user terminal is automatically stored, a TCP/IP 13 for transferring data packet from one position to another, managing a data flow and determining whether data are correct or not when data transmission is carried out through a network, position data transmission means 14 including a global positioning system or geographic information system, communication means 15 connectable to the Internet and a sensing or artificial intelligence robot 16; an administrator server 30 comprised of position data reception means 33 for receiving position data transmitted from the position data transmission means 14, position data analysis means 34 for analyzing position data received, a plurality of databases 35, 35′, 35″, . . . in which data collected and classified by an artificial intelligence robot are stored, a plurality of search engine sub-servers 32, 32′, 32″, . . . for administering the databases, and selecting data and providing results in response to a command, a main server 31 for administering the sub-servers 32, 32′, 32″, . . . , and a control unit 36 for administering the server, the databases, an artificial intelligence robot 38 and a sensing program 37; and an Internet service provider server 20 provided with a position data transmission means 21 if necessary.

Information about all cases, in which the user searches for a specific Web site using a search engine provided by the administrator server 30 and accesses a specific Web site by directly inputting the uniform resource locator of the corresponding Web site in a browser window provided by a terminal, is automatically stored in the cookies 11 and/or temporary Internet files 12 of the user Internet terminal 10.

In addition, a variety of data are stored in the TCP/IP 13 that functions to transfer a data packet from one position to another, manage the flow of data and determine whether data are correct or not when data transmission is carried out through a network.

The information automatically stored in the cookies 11 and/or temporary Internet files 12 of the user terminal 10 and the TCP/IP 13 is utilized when the user accesses a search engine to search for information and inputs a keyword thereafter.

That is, when the user accesses a search engine to search for information and inputs a keyword, the search engine learns the characteristics of the information automatically stored in the cookies 1 i and/or temporary Internet files 12 of the user terminal 10 and the TCP/IP 13, and displays first search results contained in a category having characteristics identical with the characteristics of information obtained from previous search results.

In the administrator server 30, there are set up a plurality of DBs 35, 35′, 35″, . . . in which information is classified into various categories according to characteristics and stored.

An administrator surfs a variety of Web sites, classifies information on the 30 Web sites and stores the information in the administrator DBs 35, 35′, 35″, . . . Another Web site administrator 50, which allows his Web site to be searched for by a search engine, registers the characteristic of his Web site according to classification determined by the administrator of the search engine in advance.

The administrator allows information to be correctly searched for by precisely classifying the information.

The information is classified according to various classifications, such as regions, sections, kinds, related fields and the like. When a piece of information falls under two or more classes, the information is registered in all the corresponding classes.

Any device, provided that it has an Internet access function like a personal computer, personal digital assistant or mobile phone, can obtain a variety of information while accessing a Web site, can generate and store cookies and/or temporary Internet files in which information about a Web site is automatically stored when the device accesses the Web site, and has a TCP/IP enabling data transmission through a network, can be employed as the user terminal 10.

The administrator server 30 includes not only the administrator DBs 35, 35′ and 35″ but also a means for bi-directionally accessing the user terminal 10, searching the cookies I 1, the temporary Internet files 12 and the TCP/IP 13 and learning the characteristics of the information, preferably, a sensing program. The sensing program can be easily constructed by those skilled in the art.

Additionally, a search engine of the administrator server 30 is provided with a means for excluding the application of the Internet search system of the present invention, so random search results are displayed like a general search engine when the user desires general information search.

That is, when the user desires information different from information obtained, results about all related information and Web sites are displayed without the learning of the characteristics of the cookies 11 and/or the temporary Internet files 12 and the TCP/IP 13.

An embodiment of the present invention is described below. First of all, the user who searches for a specific Web site is furnished with necessary information in such a way as to access the Internet through the user terminal 10 and search a variety of Web sites.

At that time, information about the Web site 30 accessed by the user is stored in the cookies 11 and/or temporary Internet files 12 of the Internet access means 10.

Additionally, a variety of data are stored in the TCP/IP 13 that functions to transfer a data packet from one position to another, manage the flow of data and determine whether data are correct or not when data transmission is carried out through a network.

The administrator surfs a variety of Web sites through the artificial intelligence robot 16, classifies information on the Web sites and stores the information in the administrator DBs 35, 35′, 35″, . . . Another Web site administrator 50, which allows his Web site to be searched for by a search engine, registers the characteristic of his Web site according to classification determined by the administrator of the search engine in advance.

Thereafter, when the user inputs a keyword to search for specific information using the search engine provided by the administrator server 30, the administrator server 30 bi-directionally accesses the user terminal 10, searches the cookies 11 and/or the temporary Internet files and the TCP/IP 13, learns the characteristics of the cookies 11 and/or temporary Internet files 12 and the TCP/IP 13, and transmits from the administrator DBs 35, 35′, 35″, . . . to the user terminal 10 information of a category and information about Web sites having characteristics identical with the characteristics learned.

For example, if the user has obtained many medical treatises through the Internet, the cookies 11 and/or temporary Internet files 12 of the user terminal 10 are mostly those related to the medical treatises. If the user inputs a keyword “megrim!” to search for information using a search engine provided by the administrator, the administrator server 30 bi-directionally accesses the user terminal 10, searches the cookies 11 and/or temporary Internet files 12, learns that the characteristic of most generated cookies 11 and/or temporary Internet files 12 is a “medical treatise”, searches the administrator DBs 35, 35′, 35″, . . . for information about medical treatises on megrim and related Web sites first, and outputs search results.

Search engines employed in the present invention can be classified into search engines using a Global Positioning System (GPS) or Global Information System (GIS) according to the user positioning means, search engines using a method of inputting a keyword along with a predetermined symbol, search engines using a method of ascertaining the position of a server in a communication network used by the user, and search engines using a method of determining whether the hypertext links of administrative districts formed on the search engines are clicked.

Meanwhile, the position of the user is ascertained using not only the user's land register, land number, zip code and Internet protocol address, a host and an Internet protocol provider but also information provided by the artificial intelligence robot 38 provided by the sensing program 37 of the administrator server 30.

The databases 35, 35′, 35″, . . . are each organized according to subjects, industries, keywords and regions. Subject, industry and keyword-based search can be carried out using subjects, industries and keywords. The subject, industry and keyword-based search starts from searching information near the position of the user on the basis on the position of the user ascertained by the user positioning means 33 and 34, and their results are outputted.

For the search engines using the GPS or GIS, the user positioning means is comprised of the position data transmission means 14 mounted in the user terminal 10, a satellite 60 for receiving position data transmitted from the transmission means 14 of the user terminal 10 and transmitting them to the reception means 31 of the administrator server 30, the position data reception means 21 for receiving position data transmitted from the satellite 60, the position data analysis means 34 for analyzing position data received, and the control unit 36 for outputting corresponding information near the user on the basis of regional indices of the DBs 35, 35′, 35″, . . . according to analysis results.

The position data transmission means 14 mounted in the user terminal 10 is connected to the communication means 15 of the user terminal 10, so it automatically transmits position data to the satellite 60 while the communication means 15 operates.

The transmitted position data are received by the position data reception means 33 of the administrator server 30 through the medium of the satellite 60. The received data are analyzed and used to output corresponding information in the order of geographical vicinity when the user operates the search engine to obtain information.

Outputted information is transmitted to the user terminal 10 through the server 30, and the user select appropriate information from the information provided to him.

For the search engines using the method of inputting a keyword together with a predetermined symbol, the user positioning means is comprised of a regional code unit (not shown) in which an area is divided into regions by a certain method and the regions are coded with unique codes, the position data analysis means 34 for analyzing position data according to a region code inputted by the user, and the control unit 36 for outputting only corresponding information near the user on the basis of the regional indices of the DBs 35, 35′, 35″, . . . according to analyzed position data.

That is, the administrator server 30 is previously provided with numbers for indicating regions. If one of the numbers is inputted in combination with a keyword when the user inputs the keyword or is inputted before subject or industry-based search is performed, output starts from corresponding information near the user.

In more detail, regional codes are previously made in the form of zip code, and the regional codes are allocated to regional indices, respectively. When the user inputs a regional code corresponding to his position while being combined with a keyword in the front or back thereof the position data analysis means 34 recognizes the regional code while separating it from the keyword and causes the control unit 36 to perform search. Corresponding information near the user starts to be outputted, outputted information is transmitted to the user terminal 10 via the server 30, and the user selects appropriate information among provided information.

In the meantime, for search engines using the method of ascertaining the position of the server of a network being used by the user, the user positioning means is comprised of the satellite 60 for receiving and transmitting position data transmitted from the position data transmission means 21 mounted in the ISP server 20 used by the user to access the search engine server 30 and transmitting the position data, the position data reception means 33 for receiving the position data transmitted from the satellite 60, the position data analysis means 34 for analyzing received position data, and the control unit 36 for outputting only corresponding information near the user on the basis of the regional indices of the DBs 35, 35′, 35″, . . . according to analyzed position data.

The position data transmission means 14 in the search engine using the GPS or GIS is replaced with the position data transmission means 21 mounted in the ISP server 20 used.

Meanwhile, for the search engines using the method of determining whether the hypertext links of administrative districts formed in the search engine are clicked, the user positioning means is comprised of the regional code unit (not shown) in which an area is divided into regions by a certain method and the regions are coded with unique codes, the hypertext links for displaying the regional indices 40, the position date analysis means 34 for analyzing position data according to a regional code inputted by the user, and the control unit 36 for outputting only corresponding information near the user on the basis of the regional indices of the DBs 35, 35′, 35″, . . . according to analyzed position data.

That is, when subject, industry or keyword-based search is performed after the user clicks a hypertext link indicating a region, data are analyzed by the position data analysis means 34 according to the hypertext link clicked by the user, and the control unit 36 outputs only corresponding information near the user on the basis of the regional code unit (not shown), in which an area are divided into regions by a certain method and the regions are coded with unique codes, and the regional indices of the DBs 35, 35′, 35″, . . .

Additionally, the position of the user can be easily ascertained by the sensing program 37 included in the administrator server 30 in such a way as to receive position data from the artificial intelligence robot 16 mounted in the user terminal 10 with the consent of the user.

In such search engines, only information at a corresponding region is outputted by the ascertainment of the position of the user at the same time the user accesses a search engine or the input or click of the user. When the user desires to obtain information at a wider region and clicks a hypertext link indicating the wider region, information at a region wider than the region at which the information is first searched for is outputted.

For example, when search is performed at a lower region “Ogeum-dong” and a hypertext link indicating an upper region is clicked, information at the upper region “Songpa-gu” is outputted.

In this invention, an area can be divided into regions according to administrative division. However, the division is not limited to this, but can be randomly carried out.

Meanwhile, the search engine of the present invention can be constructed to perform various language conversions so that it is utilized worldwide.

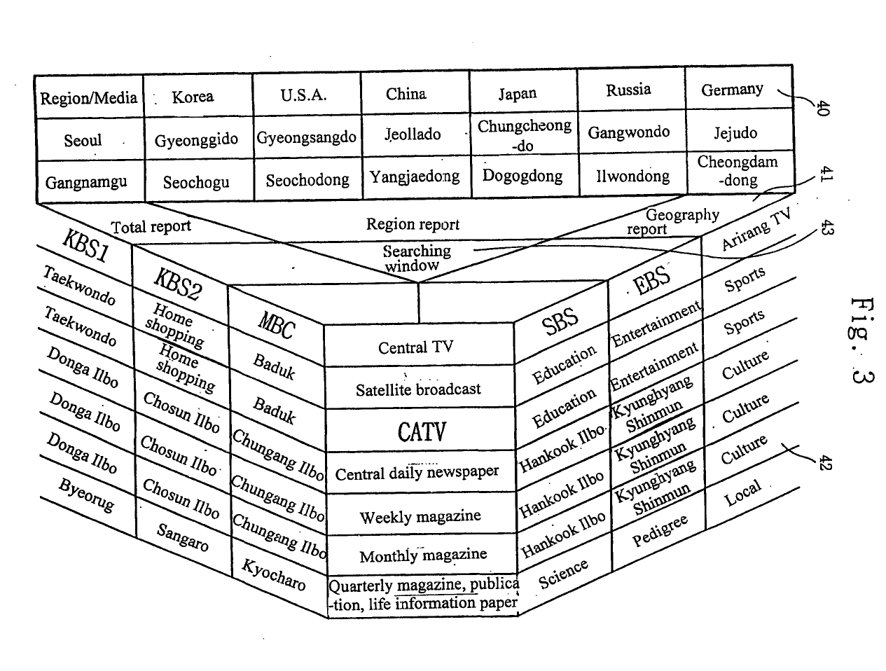

A method of displaying a screen in the search engine of the present invention is described below with reference to FIG. 3 showing an example that a search screen is displayed on a monitor of the user terminal 10.

In more detail, a hypertext link is constructed in a 3D form. In the hypertext link, a regional index group 40 is arranged on one side thereof, a subject index group 41 is arranged on another side thereof,.an industrial index group 42 is arranged on still another side thereof, and a query box 43 is arranged at the center thereof Information common to at least two of the regional, subject and industrial index groups can be selected and provided.

Additionally, two of the regional, subject and industrial index groups 40, 41 and 42 can be positioned on one side, and one index group can be positioned at the center of the remaining two sides.

FIG. 3 is a view of an example showing results obtained by entering a keyword “mass media” into the query box. When the user clicks “MBC” of the results, a homepage address of MBC or one of various broadcast programs appears on the top. In this case, a homepage of MBC is accessed and a screen of the homepage is displayed under a satellite broadcast of FIG. 3 when the user clicks the homepage address, while one of the various broadcast programs is displayed in real time when the user clicks the broadcast program.

Although a simple example is described, the present invention can be applied in various ways.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Industrial Applicability

As described above in detail, in the Internet search system and method for easy search in accordance with the present invention, the search engine in which a user classifies various pieces of Web site information into categories and stores them in DBs, the characteristic of Web sites having been accessed by the user is learned using cookies and/or temporary Internet files formed in the user Internet access means when the user performs search through the search engine, and search results are outputted according to a learned characteristic and keyword-based search as well as subject-based search is employed Additionally, information is databased so that the information is classified according to administrative regions and information near the user is first outputted as search results by ascertaining the position of the user or inputting a predetermined symbol. As a result, time and effort to select desired information can be saved, and regional, industry and subject index groups are arranged in a three-dimensional form so desired information can be accurately searched for using a single query box.

1. An Internet search system for easy search, comprising:
a user terminal 10 for accessing the Internet, searching a variety of Web sites and obtaining necessary information, said user terminal being comprised of cookies 11 and/or temporary Internet files 12 in which information about Web sites having been accessed by the user terminal is automatically stored, a TCP/IP 13 for transferring data packet from one position to another, managing a data flow and determining whether data are correct or not when data transmission is carried out through a network, position data transmission means 14 including a global positioning system or geographic information system, communication means 15 connectable to the Internet and a sensing or artificial intelligence robot 16;
an administrator server 30 comprised of position data reception means 33 for receiving position data transmitted from the position data transmission means 14, position data analysis means 34 for analyzing position data received, a plurality of databases 35, 35′, 35″, . . . in which data collected and classified by an artificial intelligence robot are stored, a plurality of search engine sub-servers 32, 32′, 32″, . . . for administering the databases, and selecting data and providing results in response to a command, a main server 31 for administering the sub-servers 32, 32′, 32″, . . . , and a control unit 36 for administering the server, the databases, an artificial intelligence robot 38 and a sensing program 37; and
an Internet service provider server 20 provided with a position data transmission means 21 if necessary.
